(19) United States
(12) Patent Application Publication
(10) Pub. No.: US 2008/0142484 A1
(43) Pub. Date: Jun. 19, 2008

(54) Auxiliary method for wet etching by oscillation flow modification and device for the same

(75) Inventor: Wang Ming-Wen, Banciao City (TW)

Correspondence Address: Haverstock & Owens LLP, 162 North Wolfe Road, Sunnyvale, CA, 94086, US

(73) Assignee: Oriental Institute of Technology

(21) Appl. No.: 11/821,159

(22) Filed: Jun. 22, 2007

(30) Foreign Application Priority Data
Dec. 15, 2006 (TW) 095147311

(51) Int. Cl. B44C 1/22; C23F 1/02

(52) U.S. Cl. 216/108; 156/345.11; 156/345.15; 216/100

(57) ABSTRACT

The present invention provides an auxiliary method for wet etching by oscillation flow modification and an device for the same. The method for wet etching by oscillation flow modification includes steps of providing a metallic substrate, etching the metallic substrate with an etchant, and oscillating the etchant during etching the metallic substrate.

### FIELD OF THE INVENTION

This invention relates to a method for wet etching and a device for the same, and more particularly to an auxiliary method for wet etching by oscillation flow modification and a device for the same.

### BACKGROUND OF THE INVENTION

The etching applied in metallic substrates includes dry and wet etching, but in the process of the dry etching, a mixture of SiCl₄, N₂, Cl₂ and NH₃, and another mixture of SiH₄, N₂ and O₂ must be used, or etching the metallic substrates in Chloride gas having a high temperature in the range of 250° C. to 300° C., which is high toxicant and corrosive. Further, the by-products of metal halides in the dry etching would contaminate the etched surface easily, which is disadvantageous to the verticality of the side wall, and all the deficiencies mentioned above limit the application of dry etching in metallic substrate.

On the contrary, wet etching is extensively applied in cream solder printing metal mask, printed circuit board of copper foil and chromium plate fabrication, and the popular etchants of wet etching in Taiwan include cupric chloride, ferric chloride and alkaline ammonia etchants. The alkaline ammonia etchant has the advantages of well safe and stability, and high etching rate. However, the over-fast etching rate of the alkaline ammonia etchant is easy to cause the side-etching on the bottom of the photoresist layer, i.e. the undercutting phenomenon, and the etching process thereof would bring the pungent smell easily. As to the cupric chloride and the ferric chloride etchants, the cost thereof are low and the waste solutions caused therefrom are recyclable. Nevertheless, the difference from the alkaline ammonia etchant is that the cupric chloride and the ferric chloride etchants would easily produce the cupric chloride and the ferric chloride crystals, which would interfere with fabricating process, even on the low working temperature compared with the alkaline ammonia etchant. As to the verticality of the side wall, it is also bad because of the over-fast etching rate of the cupric chloride and the ferric chloride etchants, which is just like that on the alkaline ammonia etchant.

During the wet etching process, the chemical reactants in the etchants must pass through the boundary layer via diffusion mechanism to contact the surface of the etched materials, and consequently the chemical etching reactions would occur and produce the reaction products. For specific etched materials, there is usually more than one etchant that can etch effectively but will not etch other materials. Therefore, the wet etching processes have a high selectivity for different materials. However, except the crystal orientation that may affect the etching rate, the chemical reactions are non-directional, and hence wet etching is substantially an isotropic etching. Isotropic etching means the wet etching will not only perform in vertical direction but also in horizontal, which leads the “undercutting.”

In order to improve the etching rate in a specific direction and decrease the etching rates in other directions, the common tactics include increasing the kinetic energy of the etching in a reacting region, increasing the supplement of reactants, and accelerating the remove of the reaction products. The means to achieve the forgoing tactics include nebulizing the etchant by jets, or applying a impulsive flow to the reaction region. But the tactic of increasing the reacting energy by improving the kinetic energy of fluids is only suitable for milli-sized Integrated Circuitry or that non-emphasized on vertical of the side wall. When target size is under micro-sized, the mentioned etching process will lead rough surface because of the uneven etching rates. The reason is that the chemical fluid flow in the boundary layer is almost static, and there is only a slow and small fluid flow approaching to the etching surface because of the concentration difference between the diffusion layer nearby and the boundary layer. From the reaction region of which the fluid velocity is zero to the region of which the fluid velocity has been recovered to the normal velocity of the outside region is defined as the diffusion layer. Even we increase the velocity gradient of the diffusion layer by improving the fluid velocity of the outside region, the width of the diffusion layer would only decrease to about 100 μm. Therefore, the fabricating yield of the prior wet etching process is only about 60 percents when applying in the under Micrometer-Sized metallic substrates.

In order to overcome the drawbacks in the prior art, A method and device for forming a metallic structure is provided. The particular design in the present invention not only solves the problems described above, but also is easy to be implemented. Thus, the invention has the utility for the industry.

### SUMMARY OF THE INVENTION

It is an aspect of the present invention to provide a method for forming a metallic structure. The steps of the method includes providing a metallic substrate, etching the metallic substrate with an etchant, and oscillating the etchant during etching the metallic substrate.

Preferably, the metallic substrate is a substrate with a relatively high extensibility, a relatively high thermal conductivity and a relatively high electric conductivity.

Preferably, the etchant is cupric chloride.

Preferably, the etchant is ferric chloride.

Preferably, the method further includes a step of adding a hydrogen peroxide and a hydrogen chloride to the etchant for maintaining a pH value thereof, when the pH value of the etchant increases.

Preferably, the etchant is alkaline ammonia

Preferably, the etchant has a temperature ranged between 25° C. and 45° C.

Preferably, the etchant has an oscillation frequency ranged between 23 kHz and 40 kHz.

Preferably, the method further includes a step of stopping oscillating the etchant in order to smooth a surface of the metallic structure by an etching back process.

It is another aspect of the present invention to provide a device for forming a metallic structure. The device includes an etching tank containing a etchant, a sample holder fixing the metallic structure in the etchant, and a oscillation generator oscillating the etchant.

Preferably, the device further includes a pH meter detecting a pH value of the etchant.

Preferably, the device further includes a temperature controller regulating the etchant having a temperature ranged between 25° C. and 45° C.

Preferably, the temperature controller is a thermostat water bath.

Preferably, the oscillation generator generates a oscillation frequency ranged between 23 kHz and 40 kHz.

Preferably, the oscillation generator is disposed inside the etching tank.

Preferably, the oscillation generator is disposed outside the etching tank.

It is further another aspect of the present invention to provide a device for forming a metallic structure which includes an tank containing a etchant and holding the metallic structure, and a oscillation generator oscillating the etchant.

The above aspects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating a device for forming a metallic structure with a oscillating flow according to the first embodiment of the present invention;

FIG. 2 is a diagram illustrating the variance of the etching rates on different oscillation frequencies;

FIG. 3 is a diagram illustrating the variance of the etching rates on different oscillation frequencies and different fabrication times;

FIG. 4(A) is a comparative diagram showing the results measured by Alpha-Step Surface Contour Measurement Instrument and Scanning Electron Microscope (SEM) after a general etching fabrication;

FIG. 4(B) is a comparative diagram showing the results measured by Alpha-Step Surface Contour Measurement Instrument and Scanning Electron Microscope after the wet etching with oscillation flow modification;

FIG. 5(A) is a picture showing the surface of the metallic substrate after the wet etching with oscillation flow modification;

FIG. 5(B) is a picture showing the surface of the metallic substrate after the wet etching with oscillation flow modification and an etching back process; and

FIG. 6 is a hot embossing metal mould of micro-fluid chip, which is formed by the method of wet etching with oscillation flow modification and the device of the same according to the present invention.

### DETAILED DESCRIPTION OF THE PREFERRED EMBODIMENT

The invention is described more specifically with reference to the following embodiments. It is to be noted that the following descriptions of preferred embodiments of this invention are presented herein for the purpose of illustration and description only; it is not intended to be exhaustive or to be limited to the precise form disclosed.

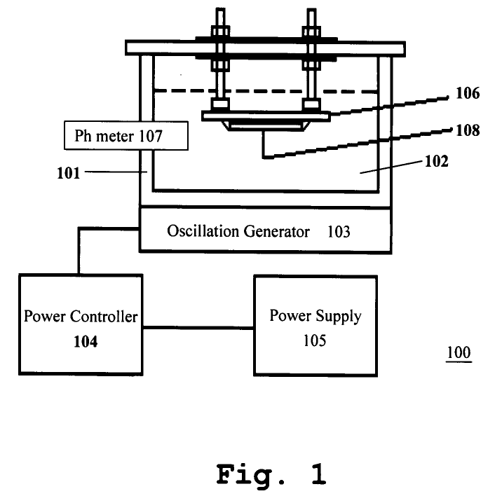

Please refer to FIG. 1, which is a schematic view illustrating a device 100 for forming a metallic structure with a oscillating flow according to the first embodiment of the present invention. The device 100 includes an etching tank 101 for containing a etchant 102, a oscillation generator 103 for oscillating the etchant 102, a power supply 105 and a power controller 104 to regulate the oscillation frequency of the oscillation generator 103, a sample holder 106 fixing the metallic structure 108 in the etchant 102, and a pH meter 107 detecting a pH value of the etchant 102.

The oscillation generator 103 generates a oscillation frequency ranged between 23 kHz and 40 l kHz, and power controller 104 has continuously variable oscillation powers ranged between 0 W˜360 W. The temperature of the etchant 102 is regulated by a thermostat water bath (which is not showed in FIG. 1.) Because the temperature of the etchant 102 has a very important influence on the chemical property of the etchant 102, the temperature control of the etchant 102 is applied by microprocessed automatic feedback device of which the error is within ±0.5° C.

Based on the device 100, the method of wet etching for forming a metallic structure by oscillation flow modification according to one embodiment of the present invention is illustrated as follows. A copperplate is provided as a metallic substrate 108, of which the width and the length are 50 mm respectively and the thickness is 50 μm, and then the metallic substrate 108 is stuck on a phenolic laminate sheet (which is not showed in FIG. 1) by epoxy resin. Further, the phenolic laminate sheet is fixed on the sample holder 106 made of Teflon in the direction of facing the oscillation generator 103. In order to evaluate the etching results, the photoresist layer is formed on the surface of the metallic substrate 108 by lithography process, which has a shape of L and the width thereof is 250 μm.

For demonstrating the feasibility of the present invention, ferric chloride etchant that has worse etching rate is chosen as the etchant 102 instead of cupric chloride or alkaline ammonia etchant that perform pretty better. The temperature of etchant 102 is regulated between 25° C. and 45° C. The chemical reactions are showed as follows:

### A. on the surface of the copperplate

Cu+FeCl₃→CuCl+FeCl₂ (1)

Cu+CuCl₂→2CuCl (2)

### B. in the etchant

FeCl₃+CuCl→FeCl₂+CuCl₂ (3)

As the etching proceeds, the etchant 120 would degrade gradually, and followed with the decrease of the etching rate. In order to stabilize the chemical property of the etchant 102 for continuous etching, it is needful to recover the etchant 102 by supplying the new reactants. Because the etchant 102 includes ferric chloride, ferrous chloride, cupric chloride and cuprous chloride that contain foreign ions of Cu and Fe, the precise temperature regulation is needed to prevent the over-produce of the foreign ions that would interfere with the recovery of the etchant 102. In the embodiment of the present invention, the common method to recover is adding hydrogen peroxide and hydrogen chloride, the reaction is as follows:

2CuCl+H₂O₂+2HCl→2CuCl₂+2H₂O (4)

By monitoring the pH value of the etchant 102 on line, when the pH value increases, the regenerators are added immediately to stabilize the chemical property of the etchant 102.

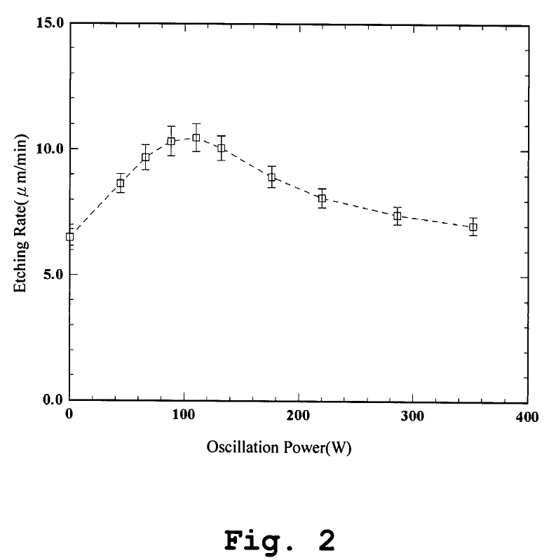

Please refer to FIG. 2, which is a diagram illustrating the variance of the etching rates on different oscillation frequencies. It is noted that the etching rate would increase obviously as the oscillation power increases. However, when the oscillation power is over 100 Watt, the etching rate would decrease instead, which means there exists a limitation of the wet etching by oscillation flow. As the oscillation power increases ceaselessly, the impulsive force of the chemical solution from the outside to the inside of the trench would also increase, which increases etching rate by thinning the diffusion layer and the boundary layer. However, when the oscillation power increases up to a specific point, the impulsive force of the chemical solution from outside to the inside of the trench would interfere with the fluid flow formed by the reaction products from the inside to the outside. This phenomena increases the thickness of the diffusion layer and the boundary layer, but decreases the etching rate to the level of the general wet etching with no oscillation flow.

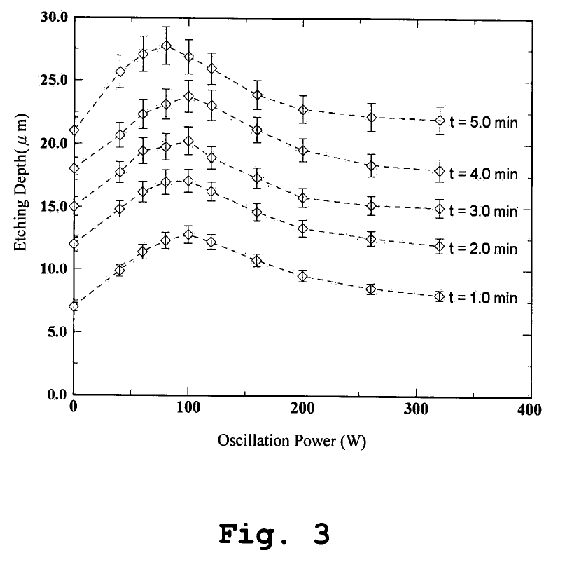

Please refer to FIG. 3, which is a diagram illustrating the variance of the etching rates on different oscillation frequencies and different fabrication times. As the FIG. 3 shows, the etching rate would increase in company with the oscillation power increasing, and when the oscillation power over 100 Watt, the etching rate would be decreased instead, as mentioned above. Besides, another important phenomenon worthy to be noted in this figure is that the etching depth of the trench increases linearly in company with the times in early stage of the fabrication times, however, as the etching depth increases continuously, the etching rate would gradually slow down. The reason is the kinetic energy of the impulsive flow of the etchant would also decrease rapidly when the etching depth in the trench increases, which leads the thickness of the diffusion layer and the boundary layer to increase gradually. Finally, the etching rate decreases to the level of the general wet etching with no oscillation flow.

Based on the mention above, it is important to study how to improve the wet etching rate of high aspect ratio trench by oscillation flow. According to prior study, in order to improve the etching rate of high aspect ratio trench, it is not enough only to develop physical properties but also need to improve the chemical properties, such as surfactant, surface wetting modified agent and active agent.

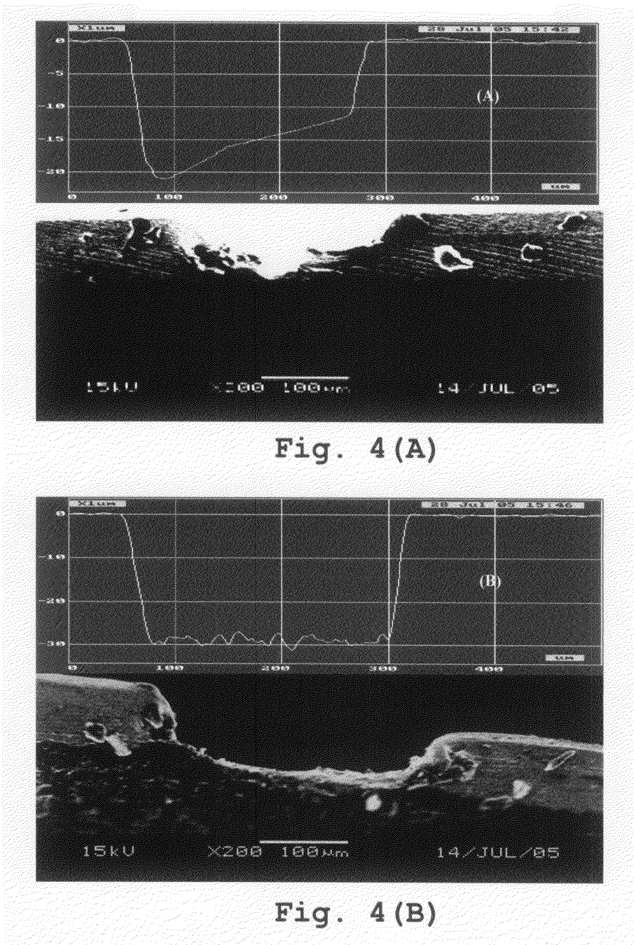

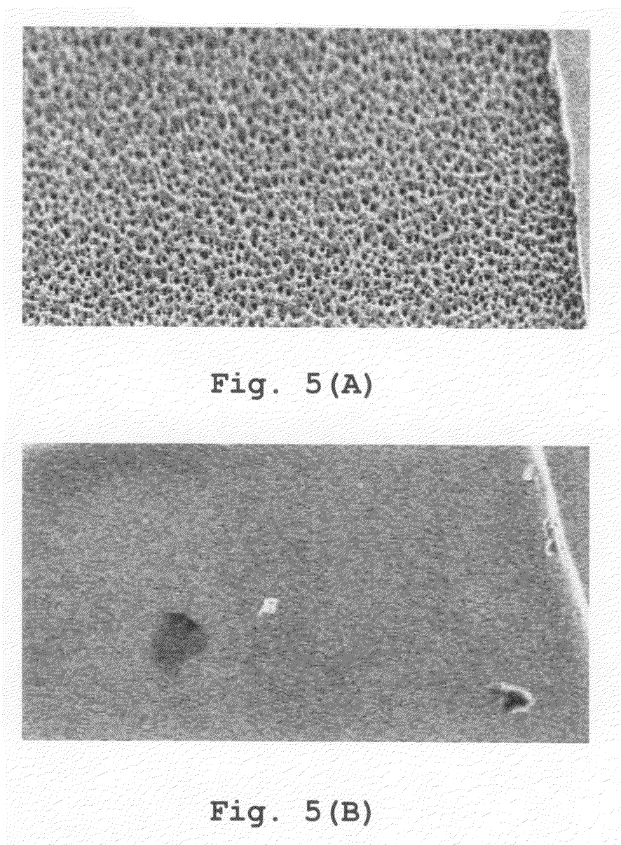

In order to realize the effect of the wet etching with oscillation flow in the uniformity of the fabrication surface and the verticality of the side wall, the copperplates which is fabricated with the wet etching by oscillation flow and without, are compared with each other by Surface Contour Measurement. Please refer to FIGS. 4(A)(B), which are comparative diagrams showing the results measured by Alpha-Step Surface Contour Measurement Instrument and Scanning Electron Microscope (SEM) after a general etching fabrication and the wet etching with oscillation flow modification. FIG. 4(A) shows the result after 5 minutes fabrication of a general etching, which presents various etching depths on the fabrication surface. The foregoing result shows that the etching rates of the general etching fabrication would vary with different etching sites, and hence would lead to a unstable etching which is not suitable for precise fabrication. FIG. 4(B) shows the result after 5 minutes fabrication of the wet etching with oscillation flow modification in 32 kHz, 90 W. From the results of Surface Contour Measurement, which presents uniform etching depths on the fabrication surface, it is clear that there is a great improvement in the verticality of the side wall and the prevention of the undercutting. The forgoing result also shows the etching rate of the wet etching with oscillation flow modification is stable no matter where the fabrication site is, which proves that the wet etching with oscillation flow modification in specific oscillation frequency and oscillation power, is indeed beneficial in enhancing the accuracy of wet etching for metallic substrate with a relatively high extensibility, a relatively high thermal conductivity and a relatively high electric conductivity. Unfortunately, in comparison with the surface fabricated by general wet etching, the surface fabricated by the wet etching with oscillation flow modification seems more rough and has numerous concaves, which is disadvantageous to the accuracy of wet etching. However, please refer to FIG. 5(A), which is a picture showing the surface of the metallic substrate after the wet etching with oscillation flow modification, the concaves on the fabricating surface are uniform, and hence are easy to be removed by a short time of a etching back process to get a smooth surface, which is showed in FIG. 5(B).

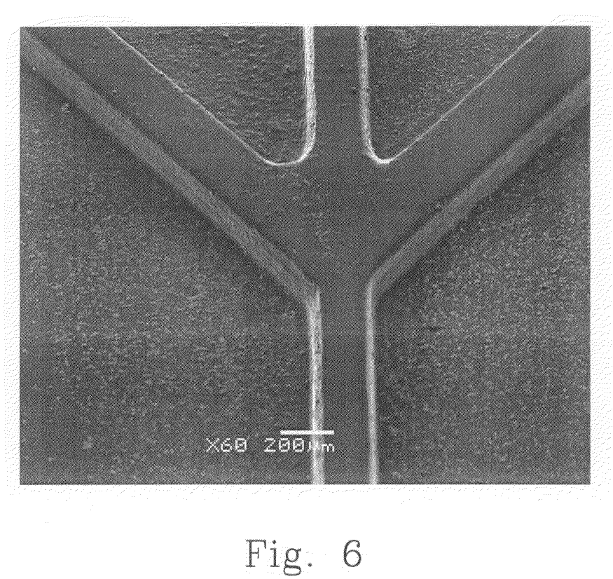

Please refer to FIG. 6, which is a hot embossing metal mould of micro-fluid chip, and the hot embossing metal mould is formed by the method of wet etching with oscillation flow modification and the device of the same according to the present invention. As FIG. 6 shows, the feasibility of the method of wet etching with oscillation flow modification and device of the same according to the present invention, is improved from the size and the appearance of the hot embossing metal mould.

From the mention above, the present invention provides an auxiliary method for wet etching by oscillation flow modification and an device for the same, which generates an oscillation flow in specific frequencies and powers by an oscillation generator to control the etching rate. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for forming a metallic structure, comprising:
providing a metallic substrate;
etching the metallic substrate with an etchant; and
oscillating the etchant during etching the metallic substrate.

2. A method as claimed in claim 1, wherein the metallic substrate is a substrate with a relatively high extensibility, a relatively high thermal conductivity and a relatively high electric conductivity.

3. A method as claimed in claim 1, wherein the etchant is cupric chloride.

4. A method as claimed in claim 1, wherein the etchant is ferric chloride.

5. A method as claimed in claim 4, further comprising a step of adding a hydrogen peroxide and a hydrogen chloride to the etchant for maintaining a pH value thereof, when the pH value of the etchant increases.

6. A method as claimed in claim 1, wherein the etchant is alkaline ammonia

7. A method as claimed in claim 1, wherein the etchant has a temperature ranged between 25° C. and 45° C.

8. A method as claimed in claim 1, wherein the etchant has an oscillation frequency ranged between 23 kHz and 40 kHz.

9. A method as claimed in claim 1, further comprising a step of stopping oscillating the etchant in order to smooth a surface of the metallic structure by an etching back process.

10. A device for forming a metallic structure, comprising:
an etching tank containing a etchant;
a sample holder fixing the metallic structure in the etchant; and
an oscillation generator oscillating the etchant.

11. A device as claimed in claim 10, further comprising a pH meter detecting a pH value of the etchant.

12. A device as claimed in claim 10, further comprising a temperature controller regulating the etchant having a temperature ranged between 25° C. and 45° C.

13. A device as claimed in claim 12, wherein the temperature controller is a thermostat water bath.

14. A device as claimed in claim 10, wherein the oscillation generator generates a oscillation frequency ranged between 23 kHz and 40 kHz.

15. A device as claimed in claim 10, wherein the oscillation generator is disposed inside the etching tank.

16. A device as claimed in claim 10, wherein the oscillation generator is disposed outside the etching tank.

17. A device for forming a metallic structure, comprising:
an tank containing a etchant and holding the metallic structure; and
a oscillation generator oscillating the etchant.
